(19) United States
(12) Patent Application Publication
(10) Pub. No.: US 2024/0141715 A1
(43) Pub. Date: May 2, 2024

(54) CURVED FENESTRATION ASSEMBLIES AND METHODS FOR MAKING THE SAME

(71) Applicant: Marvin Lumber and Cedar Company, LLC d/b/a Marvin Windows and Doors, Eagan, MN (US)

(72) Inventors: Robert M. Ross, Fargo, ND (US); James Rasmussen, Reiles Acres, ND (US); James H. Stewart, West Fargo, ND (US); Justin Schroeder-Schock, West Fargo, ND (US); Eric A. Sorby, Fargo, ND (US)

(21) Appl. No.: 18/498,655

(22) Filed: Oct. 31, 2023

Related U.S. Application Data
(60) Provisional application No. 63/421,110, filed on Oct. 31, 2022.

(51) Int. Cl. E06B 1/04; B29C 53/08

(52) U.S. Cl. CPC E06B 1/04; B29C 53/08; B29L 2031/005

(57) ABSTRACT

A fenestration assembly includes a plurality of lineal segments joined at corners. Each of the lineal segments extend between first and second ends. One or more of the lineal segments of the plurality of lineal segments is a composite lineal segment and includes a first component lineal segment and a second component lineal segment. The first and second component lineal segments are coupled at an assembly joint in an assembled configuration.

### CROSS-REFERENCE TO RELATED APPLICATIONS

This patent application claims the benefit of U.S. Provisional Patent Application No. 63/421,110, filed Oct. 31, 2022, which is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Lumber and Cedar Company, LLC d/b/a Marvin Windows and Doors of Warroad, MN. All Rights Reserved.

### TECHNICAL FIELD

This document pertains generally, but not by way of limitation, to fenestration assemblies including windows and doors.

### BACKGROUND

Fenestration assemblies including windows and doors include one or more segments jointed at corners. In some examples, fenestration assemblies include curved segments including, but not limited to, top rails of the fenestration frames. Wooden curved segments are, in one example, cut from a single piece of lumber. In other examples, multiple layers of wood are laminated together, steam heated, and then bent with the application of force supplied through a framework of pins previously set to the specified curvature for the fenestration assembly. The wooden curved segments is jointed with other wooden segments and the resulting fenestration assembly is finished (e.g., stained, painted or the like), and one or more hardware, sashes or the like are installed.

In other examples, metal or polymer fenestration segments are assembled into other fenestration assemblies. For instance, metal or polymer fenestration lineal members are selected from a warehouse of lineal members each having a specified color, finish, profile, construction (material or processing) and the like. The selected lineal member is cut to length, and the segments are jointed with one or more welds, brackets, fasteners or the like.

In these examples, if a curvature is specified, the fenestration segments are heated and curved with bending machines that deform the fenestration segments to a specified curvature. The metal or polymer fenestration segments are extruded or pultruded profile hollows and have cavities extending longitudinally through the profile hollows. In some instances, deformation of the profile hollows during bending causes deformation of walls surrounding the cavities. A deflectable rod (sometimes referred to as a snake) is optionally navigated into cavities large enough to receive the deflectable rod. The deflectable rod forces open the deformed walls.

### Overview

The present inventors have recognized, among other things, that a problem to be solved can include decreasing the maintenance multiple different permutations of lineal segments having various permutations of color, finish, construction or the like while at the same time permitting the imparting of specified curvatures without collapse of the lineal segments. For example, metal and polymer lineal members having different combinations of colors, finish, profile, construction and the like based on specifications for different fenestration assemblies, customer requests or the like. Accordingly, fenestration manufacturers produce or store (or both) lineal members having different permutations.

Upon receipt of an order or forecasted production for a fenestration assembly the manufacturer selects the lineal member having the specified color, finish, profile, construction or the like. The lineal member is cut into segments and the segments assembled into the fenestration assembly. Because fenestration assemblies have a potentially extensive set of permutations of color, finish, profile and construction maintaining one or more of a warehouse of lineal members with those permutations or production facilities to produce the permutations is a substantial outlay for the manufacturer. The manufacturer maintains a large inventory of varied lineal members, production facilities for the varied lineal members or both.

In still other examples, the deformation of lineal segments constructed with one or more of polymers or metals adds an additional step to this process that in some instances increases damage to lineal segments and thereby drains inventories, provides additional workload for production facilities or both. Polymer or metal fenestration assemblies are formed with molding processes including extrusion, pultrusion or the like. The polymer or metal is extruded (or pultruded) through a die having a specified profile for the lineal member. The lineal member includes cavities, channels, grooves or the like (collectively cavities) surrounded by walls of the lineal member, referred to herein as a hollow profile. If a curved fenestration assembly is specified, for instance with a curved top rail of a fenestration frame, fenestration sash or both, a lineal segment is cut from the lineal member. The lineal segment is heated and then deformed in a bending machine. The hollow profile deforms during bending and, in some examples, the walls surrounding the cavities collapse into the cavities. In one example, the deformation is extensive and salvaging of the curved lineal segment is not possible. The lineal segment is discarded and the process is repeated until a curved lineal segment is achieved without collapsing.

In other examples having lineal segments having a hollow profile with larger cavities (e.g., extending between interior and exterior faces of the segment) a deflectable rod (sometimes referred to as a snake) is navigated into the cavities. The deflectable rod forces open the deformed walls to attempt to restore the lineal segment to the specified profile. In some examples, the forced deformation causes damage to the lineal segment or fails to open the deformed walls and restore the segment to the specified profile. In still other examples, the deformable rod seizes in the lineal segment and is difficult to remove without damaging the lineal segment. Accordingly, if recovery is unsuccessful the lineal segment is discarded and the process is repeated until successful. In other lineal segments having tortuous or smaller profiles, a deformable rod is not an option, and accordingly curved profiles are difficult to produce (e.g., there is significant discarding) or are simply not available in a curved profile.

The present subject matter can help provide a solution to these problems, such as by a fenestration assembly having lineal segments that are comprised of a plurality of component lineal segments. The component lineal segments facilitate the selection and mixing of characteristics between component lineal segments to provide an amalgamated lineal segment and fenestration assembly having a specified combination of characteristics.

One or more (potentially all) of the lineal segments of the fenestration assembly each is a composite lineal segment and includes an assembly joint that interconnects at least a first component lineal segment with a second component lineal segment. In one example, the first component lineal segment is an exterior component lineal segment have a rugged finish, robust materials that are resistant to solar and water damage and heat and cold based deformation. In another example, the second component lineal segment is an interior component having an aesthetic finish and materials that are thermally insulative. These first and second component lineal segments are selected for their distinct qualities, and are assembled into the composite lineal segment with the assembly joint. Because the lineal segments of the fenestration assembly are constructed with distinct component lineal segments, storage of large inventories of lineal members having different permutations of characteristics is avoided. Instead, a smaller subset of first component lineal segments having different combinations of characteristics is kept on hand (or produced) and then assembled with an also smaller subset of second component lineal segments also having different combinations of characteristics. The mixing and matching of component lineal segments permits the mixing and matching of the respective associated characteristics of color, finish, profile, construction or the like of the composite lineal segments while minimizing storage or production (or both) of unitary lineal segments having varied permutations of characteristics.

Additionally, in some examples the inclusion of a curved portion is specified with the composite lineal segment. With this composite configuration the generally larger cavities in single component fenestration segments are absent. Accordingly, the delivery of deformable rods, such as snakes, is more difficult. Further, the risk of seizing of the deformable rod in the fenestration segment is increased along with associated damage to the segment. Further still, imparting complementary curvatures to component lineal segments that permits their assembly into a composite lineal segment may be difficult. At the very least multiple processing steps are conducted to separately deform each of the component lineal segments to impart the specified curvature.

The present subject matter permits the imparting of curvature to composite lineal segments having multiple component segments. In a first example, the component lineal segments are assembled at the assembly joint prior to deformation. Accordingly, the composite lineal segment is deformed collectively instead of separate deformation of each of the component segments. As described herein, a navigated curving assembly (also referred to as bending) is provided with a guide profile, and the guide profile includes the curve specified for the composite lineal segment. In a similar manner to the component lineal segments, in one example, separate interior and exterior guide profiles are assembled to provide a complementary size and contour to the composite lineal segment. For instance, the interior and exterior guide profiles match the size and contour of the composite lineal segment cross section. The interior and exterior guide profiles are coupled with fixture brackets and coupled with a curving table of the navigated curving assembly to correspond with the specified curvature.

The composite lineal segment is heated, for instance to a glass transition temperature, and coupled with an anchor (e.g., a pin, rod or the like) of a movable table boom of the curving table. The movable table boom is operated to navigate the heated composite lineal segment into the guide profiles arranged on the curving table with the specified curvature. The movable table boom rotates in an arc and moves the heated composite lineal segment through the guide profiles. The guide profiles impart the specified curvature to the heated composite lineal segment and uniformly curve each of the component segments because they are coupled at the assembly joint and moved through the guide profiles collectively (e.g., at the same time). The composite lineal segment is then ejected from the guide profiles, for instance, after setting of the curvature. In one example, the movable table boom is rotated to eject the composite lineal segment with the imparted curvature from the navigated curving assembly.

As previously described, lineal segments having tortuous or smaller profiles, such as the component lineal segments of the composite lineal segment, do not readily work with deformable rods to remedy deformation of the segments. The cavities, also referred to as segment channels are relatively small (e.g., compared to cavities in single piece segments) and deformable rods readily seize in the segments enclosing the segment channels. The present subject matter addresses this issue and facilitates the imparting of curvature to composite lineal segments described herein. One or more of the component lineal segments are optionally filled with a brace, such as a polymer, foamed polymer or the like (referred to herein as a foam brace, polymer brace or the like) that is optionally injected into one or more segment channels. The foam brace supports the component lineal segments and decreases (e.g., reduces or eliminates) collapse of the segment walls that may otherwise cause damage to the composite lineal segment. For example, the foam brace is deposited within one or more segment channels of one or more of the component lineal segment (and accordingly the composite lineal segment). The foam frame brace fills the one or more segment channels and engages with the segment walls of the segments.

As the composite lineal segment is moved through the navigated curving assembly, the foam brace supports the composite lineal segment including the walls proximate to the segment channels, and accordingly decreases deformation of the segment into the segment channels. The foam brace decreases collapsing of composite lineal segment walls that otherwise damage the profile of the composite lineal segment. Damage to the composite lineal segment, its rejection, and the need to repeat production of the composite lineal segment is thereby decreased (e.g., reduced or eliminated).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a fenestration assembly including a curved lineal segment.

FIG. 2 is a perspective view of another example of a fenestration assembly including a curved lineal segment.

FIG. 3 is a cross sectional view of the fenestration assembly of FIG. 1.

FIG. 4 is a detailed cross sectional view of a composite lineal segment of the fenestration assembly of FIG. 1.

FIG. 5A is a perspective view of one example of a navigated curving assembly configured to impart a specified curve to a navigated lineal segment.

FIG. 5B is a detailed perspective view of profile fixtures of the navigated curving assembly.

FIG. 6 is a perspective of the navigated curving assembly of FIG. 4A with a curved lineal segment extracted from profile fixtures.

FIG. 7 is a perspective view of an example profile fixture.

FIG. 8 is a perspective view of another example of a guide profile coupled with an exterior template profile.

FIG. 9A is a top view of one example of an articulating corner linkage.

FIG. 9B is a top view of one example of a linkage member of the articulating corner linkage of FIG. 9A.

FIG. 9C is a side view of the linkage member of FIG. 9B.

FIG. 10A is a top view of another example of an articulating corner linkage.

FIG. 10B is a top view and side projection of one example of a linkage member of the articulating corner linkage of FIG. 10A.

FIG. 10C is a top view and side projection of the linkage member of FIG. 10B inverted.

FIG. 11 is a perspective view of the articulating corner linkage of FIG. 9 in an initial installation configuration with lineal segments of a fenestration frame.

FIG. 12 is a perspective view of the articulating corner linkage of FIG. 10 in an initial installation configuration with lineal segments of a sash.

### DETAILED DESCRIPTION

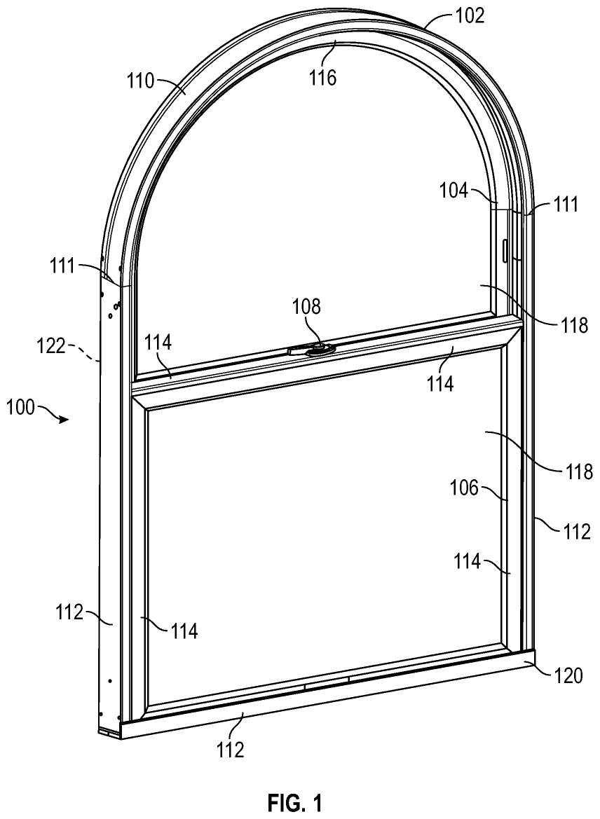

FIG. 1 is a perspective view of one example of a fenestration assembly 100, such as a window or door assembly. The fenestration assembly 100 includes a fenestration frame 102 and optionally one or more sashes. In the example shown in FIG. 1, the fenestration assembly 100 includes first and second sashes 104, 106 positioned within the frame 102. Optionally, one or both of the sashes 104, 106 are moveable within the fenestration frame 102. For instance, the one or more of the sashes 104, 106 are slidable in the manner of a single hung or double hung window within the fenestration frame 102. In another example, one or more of the first or second sashes 104, 106 is rotatable relative to the fenestration frame 102, for instance, in the manner of an awning or casement window.

Referring again to FIG. 1, the fenestration assembly 100 includes one or more glass units 118, such as insulated glass units (IGU), glass panes or the like. In another example, fenestration hardware 108 is coupled along one or more lineal segments 114 of the first or second sashes 104, 106 to permit the selective opening and closing of the sashes 104, 106. In one example, the fenestration hardware 108 is installed proximate to an interior face 120 of the fenestration assembly 100, for instance, to permit access by a homeowner or operator inside a building. Conversely, the exterior face 122 of the fenestration assembly 100 is directed outwardly, and the interior fenestration hardware 108 is isolated from the exterior face 122 to enhance security for the assembly 100.

As further shown in FIG. 1, the fenestration assembly 100, including one or more of the fenestration frame 102 or the first or second sashes 104, 106 are constructed with lineal segments. As discussed herein, the lineal segments are constructed with a polymer including polymers, composites of polymers and filaments (e.g., glass fibers, metal fibers) or the like. These lineal segments are interconnected with one or more fasteners such as welds, screws, adhesives or the like, for instance at miter cut corners, butt interfaces or the like. In another example, as described herein, corner keys are another example of fasteners, and are installed between lineal segments to facilitate coupling of the lineal segments.

As shown in FIG. 1, the fenestration frame 102 includes a plurality of lineal segments including at least one composite lineal segment 110 as well as additional lineal segments 112. The lineal segments 110, 112 include one or more of curved lineal and straight lineal segments that are interconnected, for instance, with welds, adhesives, fasteners such as corner keys or the like. In one example, the components of the lineal segments 110, 112 are selected from a catalog, online database or the like according to customer or builder specifications including, but not limited to, one or more of finish, color, material of construction, mechanical characteristics, thermal insulation capabilities or the like. The lineal segments 110, 112 once selected are optionally cut to size (e.g., length, miter cuts or the like), and joined to form the fenestration frame 102.

In a similar manner, a fenestration assembly including one or more sashes, such as the first or second sash 104, 106, includes associated lineal segments 114, 116 that are interconnected to form the perimeter of the first and second sashes 104, 106. In a similar manner to the lineal segments 110, 112 of the fenestration frame 102, lineal segments 114, 116 of the sashes 104, 106 are selected based on customer or builders specifications for one or more of finish, color, material of construction, mechanical characteristics, thermal insulation characteristics or the like. The segments 114, 116 are optionally cut to size (e.g., length, miter cuts or the like) and interconnected with one or more of welds, adhesives, corner keys, combinations of the same or the like to form the first and second sashes 104, 106. In another example, the glass units 118 are installed within the first or second sashes 104, 106. The fenestration hardware 108, where present with operable sashes 104, 106, is installed with the sashes 104, 106 to permit the selective locking and unlocking of the first and second sashes 104, 106 (also referred to as securing and unsecuring) to permit opening relative to the fenestration frame 102.

Referring again to FIG. 1, in another example, one or more of the lineal segments 110, 112, 114, 116 are composite lineal segments. The composite lineal segments 110 as described herein include two or more component lineal segments that are interconnected, for instance, at one or more assembly joints to provide a consolidated lineal segment including the component lineal segments. One example of a composite lineal segment is the composite lineal segment 110 in FIG. 1. The assembly of the composite lineal segment 110 permits the selection of component lineal segments having different properties, for instance, for the interior face 120 of the fenestration assembly 100 and the exterior face 122 of the fenestration assembly. In one example, an exterior facing component lineal segment includes properties such as color, finish; solar resistance, mechanical characteristic, thermal strength (e.g., high glass transition temperature), thermal insulation or the like that enhance the durability, appearance or both of the component lineal segment along the exterior face 122 of the fenestration assembly 100. Similarly, the interior facing component lineal segment of the composite lineal segment 110 is optionally selected for an aesthetic color, finish, mechanical characteristic, thermal insulation or the like for the interior face 120 of the fenestration assembly 100. The selection of component lineal segments facilitates the maintenance and storage of a compact catalog (e.g., compact warehousing, on site product or the like) that permits wide variation in the resulting composite lineal segments. This catalog and maintenance of the same is compact compared to maintenance and storage of non-composite (e.g., unitary) lineal segments having the desired permutations of properties otherwise available with selection and assembly of composite lineal segments.

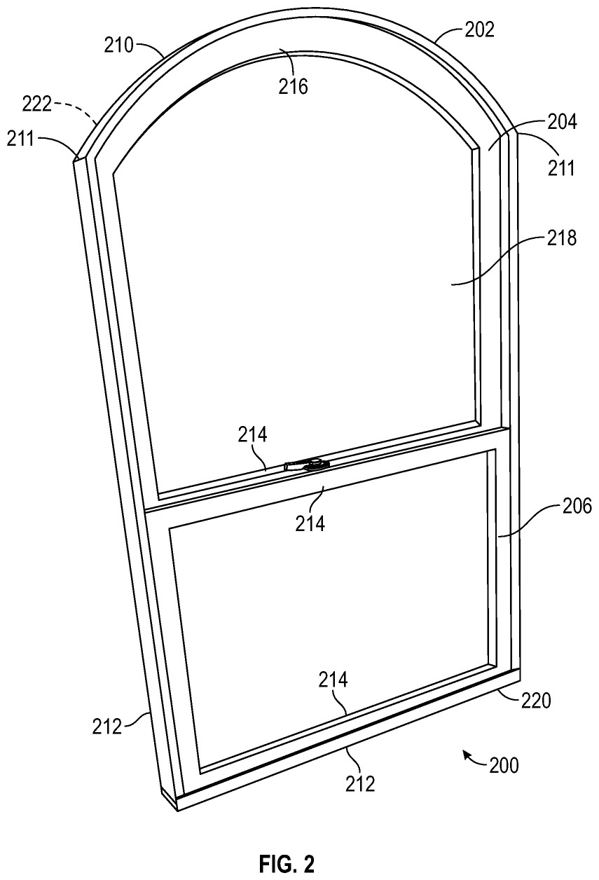

As described herein, these component lineal segments are selected and coupled together to form the composite lineal segment 110. In one example, the composite lineal segment 110 is further processed, for instance, to provide the curved configuration shown in FIG. 1 (and FIG. 2). Optionally, the curve of the composite lineal segment 110 is collectively imparted to the component lineal segments, for instance, after coupling of the component lineal segments along or with the assembly joints described herein. Accordingly, each of the component lineal segments collectively assumes or is imparted with the specified curvature for the fenestration assembly 100 at the same time and in a single curving process or step. Accordingly, repeated curving processes, such as bending or the like otherwise used with multiple components are decreased. Instead, the composite lineal segment 110 is collectively curved in a single processing step that provides the composite lineal segment 110 as shown in FIG. 1 having the specified curvature.

FIG. 2 shows another example of a fenestration assembly 200. In this example, the fenestration assembly 200 includes one or more components similar, but not identical to, the components of the previously described fenestration assembly 100 shown in FIG. 1. The fenestration assembly 200 includes a fenestration frame 202 and optionally includes one or more first or second sashes 204, 206. Each of the first or second sashes 204, 206 includes a glass unit 218 installed therein. As further shown in FIG. 2, the fenestration assembly 200 is constructed with one or more lineal segments such as a curved lineal segment 210, straight lineal segment 212 as well as straight lineal segments 214, 216. As previously described, these lineal segments are, in one example, interconnected, for instance, with welds fasteners, such as corner keys, or the like to accordingly form the fenestration frame 202 and the one or more first or second sashes 204, 206 as.

As further shown in FIG. 2, in this example, the fenestration assembly 200 includes a curved lineal segment 210 having a different radius of curvature than the curved lineal segment 110 shown, for instance, in FIG. 1. For instance, in this example, the curved lineal segment 210 has a radius of curvature greater than the radius of curvature of the curved lineal segment 110 shown in FIG. 1. Additionally, frame widths, profiles (cross sections) or the like of the segments vary between the assemblies 100, 200. Accordingly, the corners 211 of the curved lineal segment 210 and the proximate straight lineal segments 212 have a different interface or a different corner angle relative to each other for joining. In contrast, in FIG. 1, the corners 111 of the curved lineal segment 110 and the straight lineal segments 112 have a relatively flush or parallel interface. For instance, the curved of the curved lineal segment 210 smoothly transitions to the straight lineal segment 110 of the fenestration assembly 100.

The fenestration assembly 200 shown in FIG. 2 includes corners 211 having a relatively more abrupt transition or angled profile in comparison to the corners 111. The corners 211 and 111 accordingly have different, miter cuts, corner angles, welds, fasteners or the like. As described herein, in various examples, the segments of the fenestration assemblies 100, 200 are interconnected with one or more corner keys. The corner keys are, in various examples, articulable. For instance, the corner keys are articulating corner linkages having one or more articulating joints to permit the articulation of the corner key linkages to have joint angles (also referred to as linkage angles) that match or correspond to the corner angles between a curved lineal segment 210, and a straight lineal segment 212 or the curved lineal segment 110 and straight lineal segment 212 (in FIG. 1). In various examples, as described herein, the curved lineal segments 110, 210 are curved (e.g., bent) to a variety of different radii, include miter cuts having different angles or the like and accordingly the interconnection between the curved lineal segments 110, 210 (or straight) and other straight lineal segments 112, 212 uses one or more different corner keys. In another example, the articulating corner linkages described herein are instead used to facilitate the ready interconnection between a wide variety of lineal segments having different corner angles including, but not limited to, the curved lineal segments, straight lineal segments shown in FIGS. 1 and 2 as well as other lineal segments interconnected at a variety of corner angles.

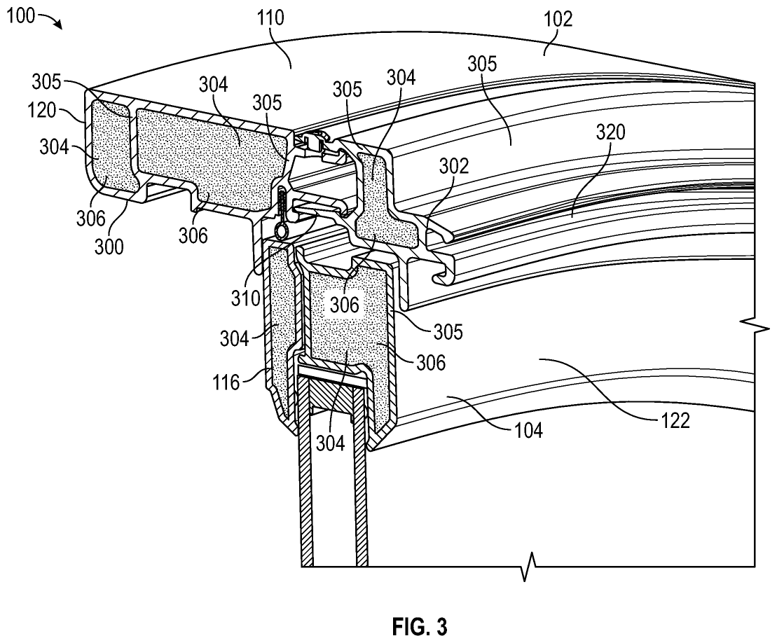

FIG. 3 is a sectional view of the fenestration assembly 100 previously shown in FIG. 1. As shown, the fenestration assembly 100 includes a fenestration frame 102 and, in this particular view, a first sash 104 coupled with the fenestration frame 102. In some examples, the fenestration frame 102 is referred to as a peripheral frame while the first sash 104 includes an interior frame having the lineal segment 116 shown in FIG. 3 and potentially other interconnected lineal segments (see FIGS. 1 and 2).

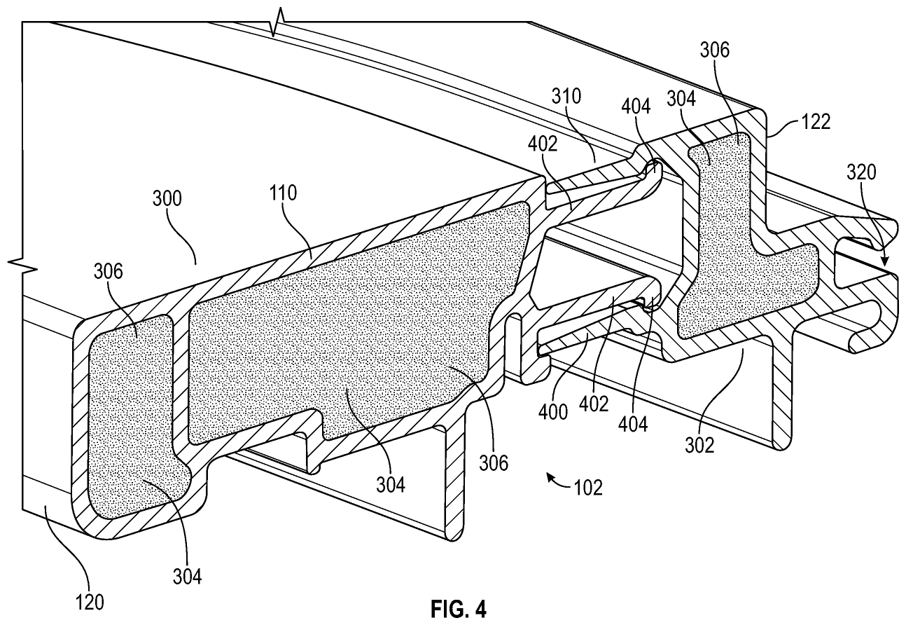

As further shown in FIG. 3, the fenestration frame 102 includes the composite lineal segment 110 including two or more component lineal segments. In the example shown in FIG. 3, the composite lineal segment 110 includes a first component lineal segment 300 and a second component lineal segment 302. The first and second component lineal segments 300, 302 are joined at an assembly joint 310. Further detail of an example of the assembly joint 310 is provided in FIG. 4.

Referring again to FIG. 3, the first sash 104 includes a lineal segment 116 having, for instance, a complementary profile such as shape, curvature or the like to permit interfitting of the first sash 104 with the fenestration frame 102 and thereby permit closing and opening of the first sash 104 relative to the curved fenestration frame 102. In another example, the first sash 104 is a static component, for instance, statically coupled with the fenestration frame 102. In another example, the first sash 104 is absent, for instance, the fenestration frame 102 seats the insulated glass units, panes of glass or the like within the fenestration frame 102 itself.

Referring again to FIG. 3, as shown, the composite lineal segment 110 includes an interior face 120 and an exterior face 122. These interior and exterior faces 120, 122 correspond to the interior and exterior faces of the fenestration assembly 100. In one example, the interior face 120 of the fenestration assembly 120 includes the first component lineal segment 300 of the composite lineal segment 110. The exterior face 122 of the fenestration assembly 122 includes the second component lineal segment 302 of the composite lineal segment 110. Each of the component lineal segments 300, 302 has one or more characteristics, referred to herein as segment characteristics or the like, specified for the environment, appearance, mechanical and thermal performance of the owner, builder or the like. For instance, the component lineal segment 300 proximate to the interior face of the fenestration assembly 120 includes one or more thermal insulation characteristics, finishes, colors, materials or the like based on the specifications of the builder, owner or the like. In one example, the segment characteristics of the component lineal segment 300 includes a soft grey painted, matte finish, and has a thermal insulation characteristic configured to throttle heat transfer between the interior and exterior (e.g., a U-factor of 0.25 to 0.30 British Thermal Units per hour per square foot per degree Fahrenheit).

Conversely, the component lineal segment 302 proximate to the exterior face 122 includes segment characteristics specified for the exterior environment of the fenestration assembly 100 including, for instance, finish, color (e.g., aesthetic characteristics) as well as material characteristics including resistance to ultraviolet damage, robust materials that can withstand extremes of environmental conditions including temperature or weather. In one example, the segment characteristics of the component lineal segment 302 include a solar and weather resistant, acrylic finish, blue color, with a tensile strength of 20,000 pounds per square inch and has a thermal insulation characteristic (U-factor of 0.50). In an example, an owner, builder or the like selects a component lineal segment 300 and a second component lineal segment 302 based on segment characteristics desired for the interior and exterior of the fenestration assembly 100. These components, when selected, are pulled from respective bins, housings, storage areas or the like, are optionally cut from elongate lineal members and then are joined together, for instance, at the assembly joint 310 to provide the composite lineal segment 110. The selection of the component lineal segments 300, 302 permits the storage and selection of a wide variety of component lineal segments while at the same time decreasing the maintenance of a large number of distinct lineal segments having varied characteristics. Instead a builder, architect, owner or the like specifies characteristics and a catalog of lineal segments 300, 302 are consulted and selected from to provide a combination of segments 300, 302 having the specified characteristics for the composite lineal segment 110.

As previously discussed, the composite lineal segment 110 is constructed with two or more component lineal segments 300, 302 joined at one or more assembly joints 310. The assembled composite lineal segment 110 is ready for curvature, for instance, the imparting of a curvature provided by a curving assembly such as a navigated curving assembly as described herein. For example, the composite lineal segment 110 is in an assembled configuration such as the configuration shown in FIGS. 3 and 4. As described herein, the composite lineal segment 110 in the assembled configuration is heated (e.g., to a glass transition temperature), and is processed through the navigating curving assembly to impart the specified curvature corresponding to a desired radius, profile or the like for the fenestration assembly 100.

In a similar manner, the frame of the first sash 104, for instance, including the lineal segment 116 is similarly processed in the navigating curving table shown herein to impart a specified curvature that is complementary to the curvature of the composite lineal segment 110.

As further shown in FIG. 3, one or more of the lineal segment 116 and the composite lineal segment 110 include segment channels 304. The segment channels 304 are, in various examples, enclosed by one or more segment walls 305. In other example constructions, the segment walls 305 when curved collapse into the segment channels 304 and accordingly trigger rejection, discarding and reproduction of one or more of the segments to generate fenestration frame 102, first sash 104 or the like without collapsing.

The fenestration assemblies described herein including the associated lineal segments counteract collapse of segment walls 305 with one or more polymer braces 306 introduced into the segment channels 304. The polymer braces 306 include, but are not limited to, a foam polymer, foam polymer brace or the like that is injected into the composite lineal segment 110, lineal segment 116 or the like. In one example, the polymer brace 306 is coextruded with one or more of the component lineal segments 300, 302, the lineal segment 116 or the like. In another example, the polymer brace 306 is injected within the segment channels 304 prior to processing of the composite lineal segment 110, lineal segment 116 or the like (and after extrusion). The polymer brace 306 fills the segment channels 304 (e.g., extends between segment walls 305) and provides a supporting structure in intimate contact with the segment walls 305. Upon heating (e.g., to a glass transition temperature) and curving of the composite lineal segment 110 or the lineal segment 116, the polymer brace 306 supports the segment walls 305 and accordingly decreases (e.g., eliminates or minimizes) the collapse of the segment walls 205 into the segment channels 304. Instead, the profile of the composite lineal segment 110, lineal segment 116 or the like is maintained during imparting of curvature to the respective segments 110, 116. Accordingly, damage that otherwise triggers rejection, seizing of deformable rods that are otherwise used to counter-deform segment walls or the like is thereby avoided. Instead, the polymer braces 306 provided in the segment channels 304 support the associated composite lineal segment 110, lineal segment 116 or the like and facilitate the maintenance of a specified profile of the segments 110, 116 both before imparting of curvature, during imparting of curvature as well as afterwards when the composite lineal segment 110 and lineal segment 116 are allowed to cool and set.

In another example, the polymer brace 306 including, for instance, a foam polymer or the like having gas bubbles, cavities or the like therein, provides additional thermal insulation properties to the lineal segments 110, 116, for instance, by providing a non-reticulated foam type structure that throttles heat transfer, for instance, from the interior face of the fenestration assembly 120 to the exterior face of the fenestration assembly 122 or the reverse (e.g., from the exterior 122 to the interior 120).

As further shown in FIG. 3, in one example, the exterior face 122 of the fenestration assembly 100 includes a cladding kerf 320. In one example, the cladding kerf 320 provides one or more features configured to interconnect with one or more cladding elements applied to the fenestration assembly 100 after or during installation of the fenestration assembly 100 within a rough opening. In various examples, the cladding kerf 320 receives a corresponding flange or the like provided on the cladding to couple the cladding to the fenestration assembly 100 and provide a decorative or enhanced covering to the fenestration assembly 100. In another example, the interior face 120 of the fenestration assembly 100 includes its own cladding kerf to permit the installation of interior cladding, fascia or the like for the fenestration assembly 100.

FIG. 4 is a detailed sectional view of the composite lineal segment 110 previously shown in FIG. 3. In this example, the first sash 104 is removed to provide clarity of the composite lineal segment 110. As shown in FIG. 4, the component lineal segment 300 is joined with the component lineal segment 302 at the assembly joint 310. The assembly joint 310, in this example, includes a joint socket 400. The joint socket is associated with either of the component lineal segments 300, 302, and in this example is shown with the segment 302. The assembly joint 310 includes a joint fitting 402 associated with the component lineal segment 300 (in another example associated with the segment 302). The joint fitting 402 is received within the joint socket 400 to interfit the first and second component lineal segments 300, 302. Optionally, a locking feature 404 such as, but not limited to, a detent, hook, barb, flange or the like is provided with one or more of the joint socket 400 or joint fitting 402 to interlock the first and second component lineal segments 300, 302 with the assembly joint 310.

As further shown in FIG. 4, the polymer brace 306 is within the various segment channels 304 of the first and component lineal segments 300, 302. The polymer brace 306, such as a foam polymer brace, foam brace or the like, supports the segment walls 305 and permits the imparting of curvature to the composite lineal segment 110 while decreasing (e.g., minimize or eliminate) the collapse of the component lineal segments 300, 302.

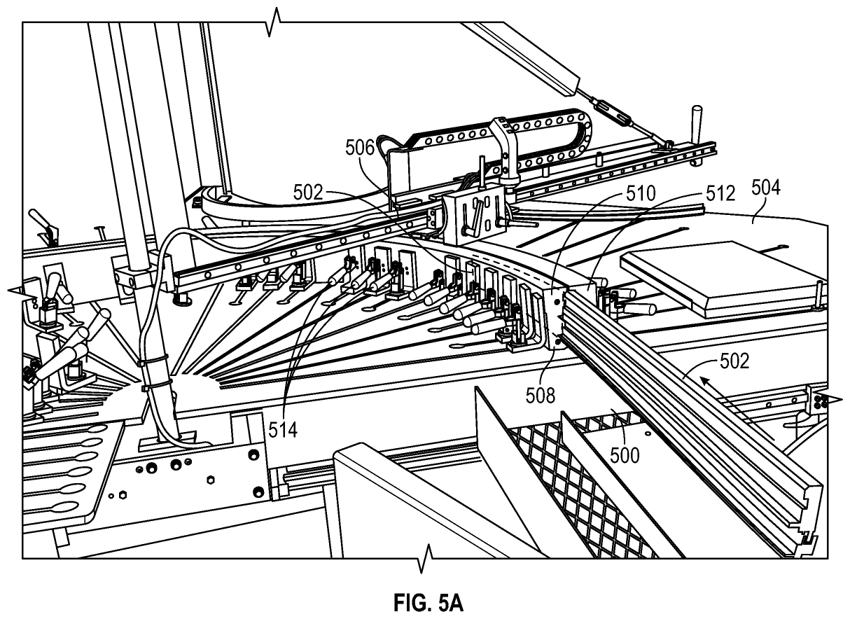

FIGS. 5A, 5B show one example of a navigated curving assembly 500. The navigated curving assembly 500 imparts a specified curvature to a lineal segment such as the lineal segment 502 shown in FIGS. 5A, 5B. In one example, the lineal segment 502 includes a composite lineal segment 110 such as the lineal segment shown in FIG. 4. The composite lineal segment 110, in one example, includes a plurality of component lineal segments, such as a first component lineal segment 300 and at least a second component lineal segment 302, that are coupled together along an assembly joint 310. The composite lineal segment 110 is processed with the navigated curving assembly 500 to accordingly impart a specified curvature provided by one or more guide profiles 508 coupled along the navigated curving assembly 500, for instance by controlled bending of the segment 110.

Referring again to FIG. 5A, the navigated curving assembly 500 includes a curving table 504, such as a planar surface, configured to couple with one or more guide profiles 508 that provide the specified curvature for processing of the illustrated lineal segment 502. In one example, the curving table 504 provides a plurality of fixture brackets 514 that couple with the guide profiles 508 and hold the guide profiles 508 statically while the lineal segment 502 is moved through the guide profiles 508 with a table boom 506 coupled with the segment 502. As described herein, movement of the lineal segment 502 along the curving table 504 and through the guide profiles 508 is a guided movement, constrained by the guide profiles 508 to impart one or more specified curvatures to the segment 502 as the segment 502 is drawn through the guide profiles 508.

As further shown in FIG. 5A, the navigated curving assembly 500 includes a table boom 506. In one example, the table boom 506 is a rotating arm, beam, piston or the like. The table boom 506 as described herein is coupled with the lineal segment 502 and navigates the lineal segment 502 (in a softened configuration, for instance after heating to a glass transition temperature) through the guide profiles 508 to impart the specified curvature to the lineal segment 502. In another example, the table boom 506 is optionally operated in reverse to eject or extract the now curved lineal segment 502 from the guide profiles 508.

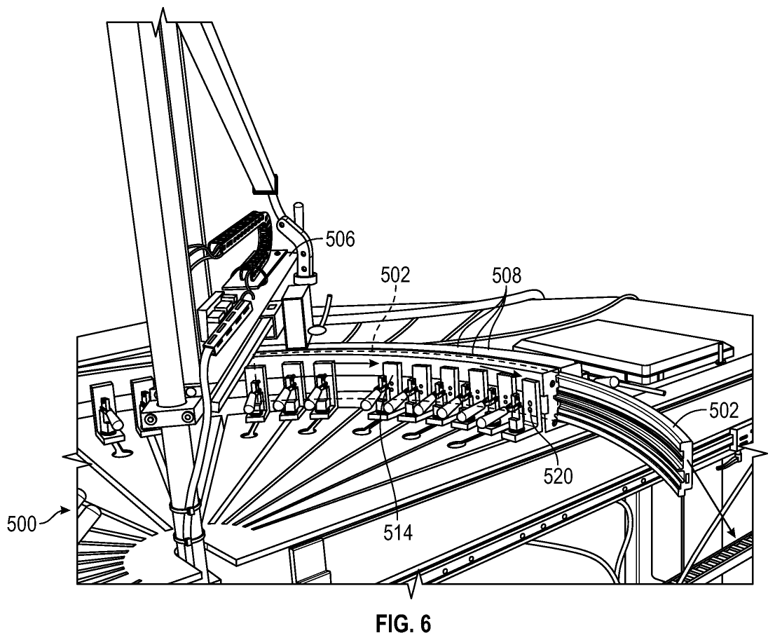

As further shown in FIG. 5A, the guide profiles 508, in one example, optionally include component profiles, such as an interior guide profile 510 and an exterior guide profile 512. Optionally, the interior and exterior guide profiles 510, 512 are provided as an integral component for the guide profile 508. In another example, the interior and exterior guide profiles 510, 512 are separate components that are assembled in the fixture brackets 514 and then coupled to the curving table 504 with the fixture brackets 514. The interior and exterior guide profiles 510, 512 correspond to or have a complementary profile to the interior and exterior portions of the lineal segment 502. For instance, as shown in FIG. 7, one example of a profile of a lineal segment 704 is provided with the guide profile 508 and is complementary to the lineal segment 502 received therein. In other examples, the guide profiles 508 include interior guide profiles 510 and the exterior guide profile is absent.

The navigated curving assembly 500, in one example, is set up to impart one or more specified curvatures to a lineal segment, such as the lineal segment 502. For instance, in one example, a specified curvature is based on a selected radius of curvature for a fenestration assembly. One or more guide profiles 508 having a complementary profile to one or more portions of the lineal segment 502 are coupled to the curving table 504. In one example, the guide profiles 508 are coupled with the curving table 504 with the fixture brackets 514. For instance, the fixture brackets 514 are slid or translated along the curving table 504 according to the specified curvature (e.g., radius of curvature). Upon reaching the specified curvature, the fixture brackets 514 are clamped to the curving table 504 to set the guide profiles 508 with the specified curvature.

FIG. 5B shows a detailed view of one portion of the navigated curving assembly 500. For instance, in the example shown, the lineal segment 502 is moving into the one or more guide profiles 508. For instance, the lineal segment is a softened lineal segment (e.g., after heating to a glass transition temperature for the component lineal segments) and is drawn into the guide profiles 508 coupled with the fixture brackets 514. In one example, the table boom 506 navigates the lineal segment 502 through the guide profiles 508 to deform the segment 502 and impart the specified curvature. A portion of the lineal segment 502 is shown in FIG. 5A in dashed lines having the curved configuration as the table boom 506 moves the lineal segment 502 into the guide profiles 508 and the guide profiles 508 impart the specified curvature to the lineal segment 502.

In one example, the guide profiles 508 include a tapered surface to facilitate movement of the lineal segment 502, for instance into and through the guide profiles 508 (movement is shown with arrows in FIGS. 5A, B). The tapered surface includes, but is not limited to, one or more of a chamfer, draft angle, rounded contour or the like that are collectively referred to as a taper. The tapered surface of the guide profiles 508 decreases snagging or collision of the lineal segment 502 with one or more of the guide profiles 508. For example, the tapered surface of the guide profiles 508 facilitates the transition of the lineal segment 502 between proximate guide profiles 508. As the lineal segment 502 transitions from an upstream guide profile 508, the widened taper of the downstream guide profile 508 readily receives the lineal segment 502 and the taper of that guide profile 508 (e.g., narrows) guides the lineal segment 502 to deform according to the specified curvature.

Examples of profile fixtures 520 are shown in FIG. 5B. The profile fixtures 520 include one or more fixture brackets 514 and one or more guide profiles 508. In the example shown in FIG. 5B, the guide profile 508 is formed as a composite profile with component interior and exterior guide profiles 510, 512. The interior guide profile 510 as well as the exterior guide profile 512, in one example, guide the segment movement through the profiles and impart the specified curvature to the lineal segment 502. In other examples, the guide profiles such as the guide profiles 508, 510, 512 transition the lineal segment 502 to the next portion of the guide profile 508, for instance, a distal guide profile 508 provided downstream of the lineal segment 502.

As further shown in FIG. 5B and previously described herein, the guide profile 508, in one example, is a composite of the interior guide profile 510 and the exterior guide profile 512. In such an example, the interior guide profile 510 guides or provides the specified interior curvature or radius to the lineal segment 502 while the exterior profile fixture 520 provides the exterior or outer radius for the lineal segment 502. In a guide profile 508 having component guide profiles a manufacturer, technician, builder or the like readily readily chooses guide profiles complementary to the configuration of the lineal segment 502. These guide profiles 510, 510 are coupled together with the fixture brackets 514 and coupled to the curving table 504. For instance, one or more of interior (inner) and exterior (outer) guide profiles are selected in correspondence with the profile of the lineal segment 502. The selected guide profiles are coupled with the fixture brackets 514 and then coupled in the specified configuration (e.g., with a specified curvature) along the curving table 504. Accordingly, in various examples, multiple inner and outer guide profiles 508 including interior and exterior guide profiles 510, 512 are readily assembled along the curving table 504 to impart curvature to a corresponding lineal segment 502.

After assembly of one or more guide profiles 508, coupling of the one or more guide profiles 508 to the curving table 504, the lineal segment 502 is heated, for instance to a glass transition temperature, and moved through the guide profiles 508 with the table boom 506. For instance, as shown in FIG. 5B, the lineal segment 502 is moved into the guide channel 516 extending through the guide profiles 508. The one or more guide profiles 508 envelope the lineal segment 502 and guide the heated segment 502 to impart the specified curvature. The polymer braces 306 provided in segment channels 304 (see FIG. 3) support the lineal segment 502 during deformation that imparts the curvature. For instance, the polymer braces 306 provide a supporting substrate in intimate contact with segment walls 305 surrounding the segment channels 304 and thereby brace the walls 305 to decrease (e.g., minimize or eliminate) deformation of the walls 305, such as collapsing, into the segment channels.

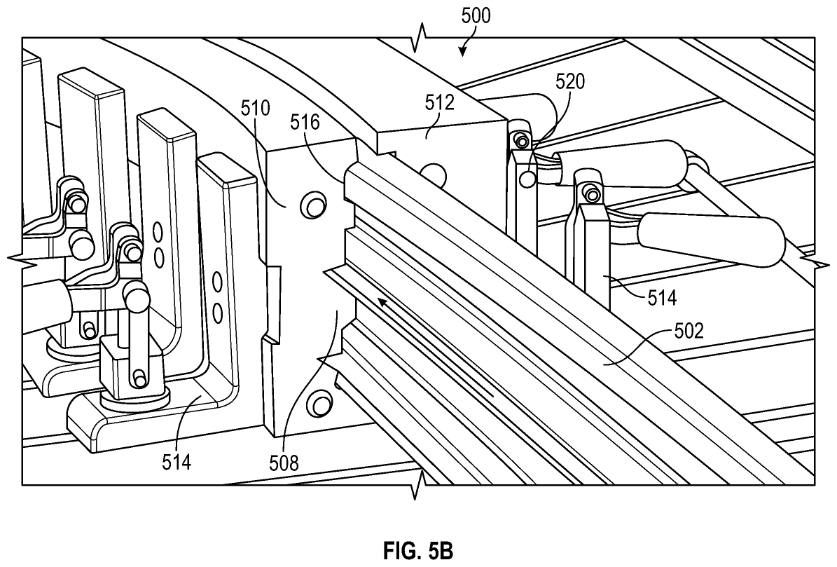

FIG. 6 shows another example of the navigated curving assembly 500 with the lineal segment 502 shown as a curved lineal segment 502. The table boom 506 has previously moved the lineal segment 502 into the guide profiles 508 and the specified curvature is imparted to the curved lineal segment 502. The curved lineal segment 502 has set (e.g., cooled) and accordingly now includes the specified curvature provided by the guide profiles 508. The table boom 506 is, in one example, operated in reverse as shown with arrows in FIG. 6 to eject the curved lineal segment 502 from the guide profiles 508.

FIG. 7 is a detailed view of one example of a profile fixture 520. The example profile fixture 520 includes a guide profile 508 coupled with one or more fixture brackets 514. In this example, the guide profile 508 is a composite profile having an interior guide profile 510 and an exterior guide profile 512. These guide profiles 510, 512 are coupled together to form the guide profile 508 and are coupled with the fixture brackets 514 to permit coupling of the profile fixture 520 with the navigated curving assembly 500 including, for instance, the curving table 504 shown in FIG. 5A.

As further shown in FIG. 7, one example of an anchor pin or rod 700 is positioned within the anchor channel 702 of the guide profile 508. The anchor pin 700 extends into the channel 702 and is coupled with the lineal segment, such as the lineal segment 502. The anchor pin 700 is, in turn, coupled with the table boom 506, and the table boom 506 moves the lineal segment 502 through the anchor pin 700. Accordingly, movement of the table boom 506 is transmitted through the anchor pin 700 to the lineal segment 502 to move the lineal segment 502 through the one or more guide profiles 508 and impart the specified curvature to the lineal segment 502.

One example of a profile of a lineal segment 704 is shown with the dashed lines provided in FIG. 7. The lineal segment 502 has a complementary profile and is readily received within the guide profile 508. As the lineal segment 502 is moved through successive guide profiles 508 the segment 502 is deformed and assumes the specified curvature corresponding to the arrangement of the guide profiles 508 along the curving table 504.

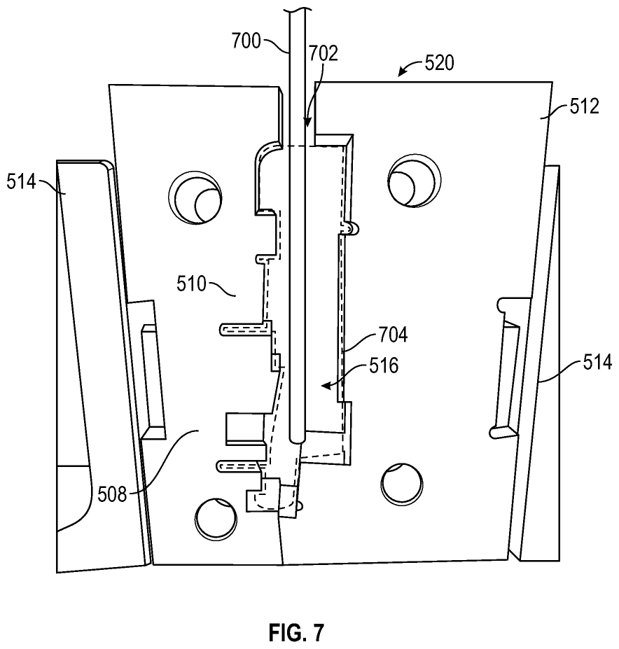

Referring now to FIG. 8, another example of a profile fixture 806 is shown. In this example, the profile fixture 806 includes one or more complementary guide profiles to form a complementary component of a fenestration assembly such as a sash frame. The example profile fixtures 806, in this example, includes a sash profile 808. The sash profile 808 is optionally fit to an exterior guide profile, such as the exterior guide profile 512 shown in FIG. 7, now used as an exterior template profile 814 for the profile fixture 806. For instance, the exterior template profile 814 is used in the manner of a jig or template to facilitate the complementary formation or imparting of a complementary specified curvature to another component of the fenestration assembly such as a sash frame.

In the example shown in FIG. 8, the sash profile 808 is coupled with the exterior template profile 814. The sash profile 808 includes a complementary frame profile 804 that matches the exterior or outer profile of a sash lineal segment. A lineal segment corresponding to the profile 804 is moved through the one or more sash profiles 808 coupled with the navigated curving assembly 500 to impart a specified curvature to the sash lineal segment. By using the exterior template profile 814 with the sash guide profile 808 the curvature imparted to the sash lineal segment is complementary to that of the fenestration frame lineal segment (e.g., segment 502 in FIGS. 5A-6) and the sash lineal segment readily fits within the fenestration frame lineal segment.

As further shown in FIG. 8, the sash profile 808, in this example, also includes an interior sash guide profile 810 and an exterior sash guide profile 812. In this example, the interior and exterior sash guide profiles 810, 812 are integral components coupled with the exterior template profile 814 (also referred to as the exterior guide profile 512 shown in FIG. 7). In another example, as described herein, the interior and exterior guide profiles 810, 812 are, in various examples, one or more components, for instance, coupled together and fastened with the curving table 504, for instance, with one or more fixture brackets 514 previously described herein.

As further shown in FIG. 8, an anchor channel 802 extends through a portion of the sash profile 808 to permit the coupling of a lineal segment received in the sash profile 808 with the table boom such as the table boom 506 previously shown in FIG. 5A. In one example, an anchor pin 700 such as that shown in FIG. 7 is coupled with the sash lineal segment (e.g., after adjustment of the position of the table boom 506 to account for the updated specified curvature of the sash in contrast to the fenestration frame). The anchor channel 802 permits the movement of the anchor pin 700 through the sash guide profiles 808 and accordingly permits the movement of the sash lineal segment through the profiles 808 to impart the specified curvature to the sash lineal segment.

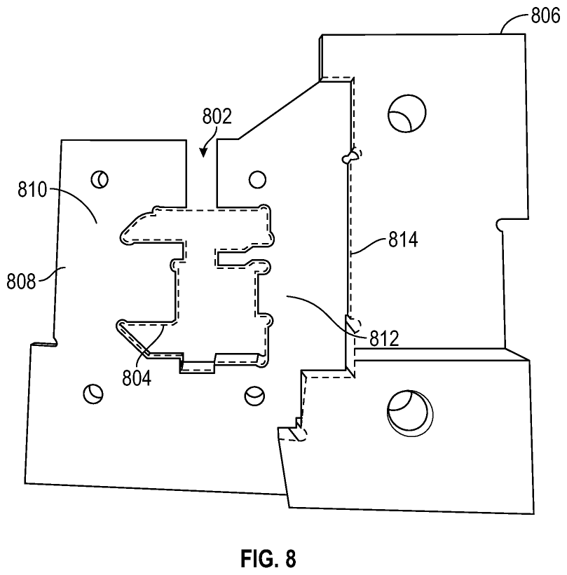

FIGS. 9A, 9B, 9C show one example of an articulating corner linkage 900. The articulating corner linkage 900 is configured for coupling one or more lineal segments such as the composite lineal segments, lineal segments or the like previously described herein including curved, straight or combinations of segments. As shown in FIG. 9A, the articulating corner linkage 900 includes an adjustable joint 902 and one or more linkage members 904, 906. The linkage members 904, 906 are rotatably coupled at the adjustable joint 902. The adjustable joint 902 rotates to permit coupling of various segments, for instance having different angled miter cuts, radii of curvature, both or the like. Optionally, the articulating corner linkage 900 is used to interconnect straight lineal segments such as the straight lineal segments shown, for instance, in FIGS. 1 and 2. In this example, the articulating corner linkage 900 is, for instance, articulated to an angle of approximately 90 degrees (a linkage angle) to match the angle of the lineal segments at their juncture (e.g., a corner angle). In various examples described herein, the angle of the articulating corner linkage 900, for instance, at its adjustable joint 902 is referred to as a linkage angle. The angle of the lineal segments at an interconnecting interface is referred to herein as a corner angle.

Referring again to FIGS. 9A, 9B and 9C, one or more of the linkage members 904, 906 includes a post 916 and a corresponding post socket 914. The post socket 914 is configured to receive the post 916 (e.g., of another member) and thereby form the adjustable joint 902 to permit the rotation of the linkage members 904, 906. In one example, the linkage members 904, 906 include interleaved joint fingers 915, for instance, two or more joint fingers 915 that facilitate the interleaving of the linkage members 904, 906, for instance, at the adjustable joint 902 to provide a strong connection between the linkage members 904, 906 and the associated lineal segments of the fenestration assembly.

Optionally, the linkage members 904, 906 are identical (e.g., left and right handed). For instance, the linkage members 904, 906 include complementary ends that permit interfitting of a right end of member 904 with the left end of member 906. In another example, the linkage members 1004, 1006 include a contoured or rounded face 917 that readily fits along a curved segment wall, for instance of the composite lineal segment 110 having an imparted curve. In yet another example, the linkage members 904, 906 include a straight face (e.g., including straight or less curved than the rounded face 917) having the fin 918 (described herein) that readily fits along a straight segment wall. The rounded and straight faces cooperatively fit with straight and curved segment members to provide snug fitting that retains the linkage 900 in place and accordingly holds the joint between lineal segments. With a curved lineal segment, the rounded face 918 provides a complementary engagement with the curved segment wall. With a straight lineal segment, the straight face having the optional fin 918 provides a linear engagement along a straight segment wall and the curved face 917 provides an opposed point or surface engagement with an opposed segment wall of the straight lineal segment.

In operation, the articulating corner linkage is manipulated to a linkage angle, for instance corresponding to a corner angle between two lineal segments that are miter cut at approximately 45 degrees to form a 90 degree angle, a miter cut at one or more different angles, to accommodate a curved lineal segment joined to a lineal segment or the like. In the example shown in FIG. 9, the articulating corner linkage is configured to rotate or pivot into angles in a range of about 60 degrees to 180 degrees with a variation of plus or minus 1 to 5 degrees. The articulating corner linkage 900 thereby fits a variety of different fenestration assemblies having different corner angles and provides a linkage system that is configurable to assume linkage angles that complement the corner angles of those fenestration assemblies.

As further shown in FIGS. 9A, 9B and 9C, the linkage members 904, 906, include linkage faces, such as an inferior linkage face 920 and a superior linkage face 922. In the example shown in FIGS. 9A, 9B, 9C, the superior and inferior linkage faces 922, 920 include one or more of reliefs 911 and spines 910 to facilitate the delivery of the linkage members 904, 906 into respective segment channels of the linear segments connected with the articulating corner linkage 900. For instance, in one example, the reliefs 911 are recessed relative to the linkage faces 920, 922 of each of the linkage members 904, 906. Conversely, the spine 910 of each of the linkage faces 920, 922 stands proud or is flush with the linkage faces 920, 922. The spine 910 provides support for the associated linkage member 904, 906 and enhances secure fitting within segment channels of the linear segments. Further, the reliefs 911 facilitate the fitting of the linkage members 904, 906 by easing the delivery of the linkage members 904, 906 into the segment channels. Upon delivery of the linkage members 904, 906 into the segment channels, the spines enhance engagement between the linkage member 904, 906 and the walls enclosing the segment channels.

As further shown in FIGS. 9A, 9B, 9C, the linkage members 904, 906 include in various examples, one or more fins such as the fins 912 provided on the linkage faces 920, 922 (inferior and superior faces respectively) as well as a fin 918 provided on one or more of the interior and exterior faces (also referred to as the inner and outer surfaces) of the linkage members 904, 906. The fins 912, 918, in one example, include a sacrificial or abradable material, for instance, a thin ridge of the linkage material that is deformed including one or more of abraded, compressed, sheared, deflected or the like upon delivery of the linkage members 904, 906 into the respective segment channels of the linear segments. The fins 912, 918 accordingly provide a firm, snug fit between the linkage members 904, 906 and the respective linear segments that provides strength for the fenestration assembly during transport and installation (e.g., to brace against deformation, relaxation of the segments or the like).

After, during or prior to installation, in one example, the linkage faces 920, 922 as well as one or more of the inner and outer faces of the members 904, 906 include grooves recesses, such as the reliefs 911 or the like. These features permit the distribution of one or more setting compounds such as hot glue, epoxies or the like around the articulating corner linkage 900 and into the segment channels. The articulating linkage 900 cooperates with the setting compounds to statically fix the lineal segments (as well as the linkage 900) during or prior to the installation of a fenestration assembly in a rough opening.

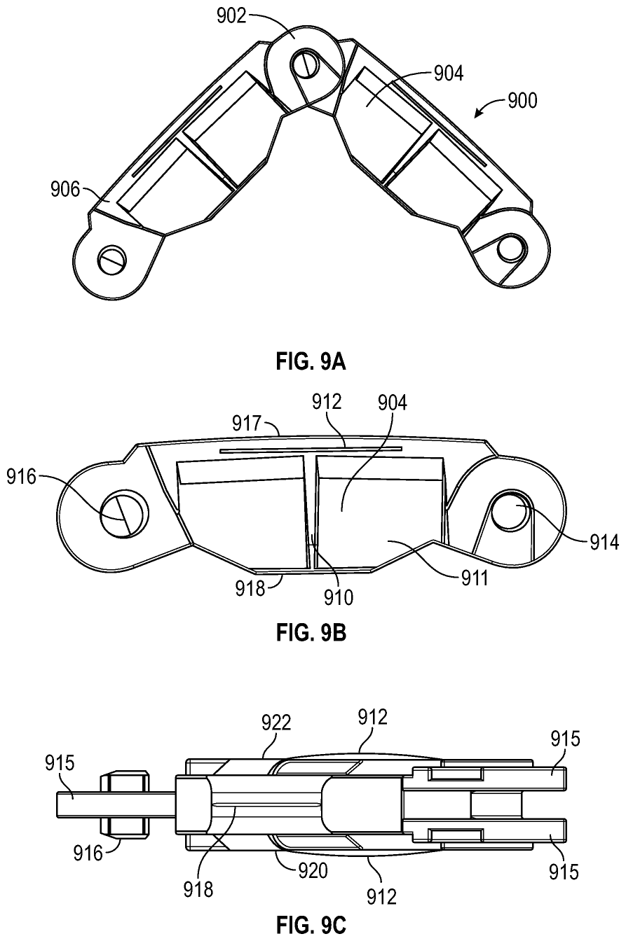

FIGS. 10A, 10B and 10C show another example of an articulating corner linkage 1000. In some examples, the articulating corner linkage 1000 is similar to the articulating corner linkage 900 previously shown and described in FIGS. 9A, 9B, 9C. For instance, the linkage 1000 includes linkage members 1004, 1006 and interconnected with an adjustable joint 1002. As further shown in FIGS. 10A, 10B, 10C, the linkage members 1004, 1006 include linkage faces 1020, 1022. In one example, the linkage face 1020 is an inferior face while the linkage face 1022 is a superior face. The linkage faces 1020, 1022 optionally include spines 1010 as well as intervening reliefs 1011 in the form of channels. The spines 1010 provide enhanced strength to the linkage members 1004, 1006 and accordingly provide a robust linkage to support the lineal segments interconnected with the articulating corner linkage 1000. Conversely, the reliefs 1011 provide gaps between the spines 1010 and, in one example, permit the distribution of one or more setting compounds such as hot melt, epoxies or the like administered to a corner of the fenestration assembly.

Optionally, the linkage members 1004, 1006 are identical (e.g., left and right handed). For instance, the linkage member 1004 is inverted (e.g., is then the member 1006) and is readily interfit with another linkage member 1004 to form the assembled articulating corner linkage 1000. In another example, the linkage members 1004, 1006 include a contoured or rounded face 1018 that readily fits along a curved segment wall, for instance of the composite lineal segment having an imparted curve. In yet another example, the linkage members 1004, 1006 include a straight face (e.g., including straight or less curved than the rounded face 1018) that readily fits along a straight segment wall. The straight and rounded faces 1017, 1018 cooperatively fit with straight and curved segment members to provide snug fitting that retains the linkage 1000 in place and accordingly holds the joint between lineal segments. With a curved lineal segment, the rounded face 1018 provides a complementary engagement with the curved segment wall. With a straight lineal segment, the straight face 1018 provides a linear engagement along a straight segment wall and the curved face 1017 provides an opposed point or surface engagement with an opposed segment wall of the straight lineal segment.

As further shown in FIGS. 10B, 10C, the articulating corner linkage 1000 at the adjustable joint 1002 optionally includes a post 1016 and a post socket 1014. In the side projections of FIGS. 10B, 10C the post 1016 is provided toward an interior of the linkage member 1004, 1006 and accordingly is recessed from the linkage faces 1020, 1022. Stated another way, the portion of the articulating corner linkage 1000 that interconnects the linkage members 1004, 1006 is housed within the linkage 1000 instead of projecting, for instance, past the linkage faces 1020, 1022. Accordingly, the articulating corner linkage 1000, like linkage 900, is fully contained between the linkage faces 1020, 1022 and thereby readily fits within one or more segment channels of the fenestration assembly without requiring penetration of the lineal segments, for instance, with routing, screws, fasteners or the like.

In another example, the linkage members 1004, 1006 include joint fingers 1024. As shown in the side projections of FIGS. 10B, 10C the joint fingers 1024 are arranged to interleave with opposed fingers 1024. The interleaved joint fingers 1024 provide a robust coupling between the members 1004, 1006 contained between the linkage faces 1020, 1022 in contrast to other joint fixtures that include screws, bolts, pins or the like extending beyond linkage members. Additionally, as shown in the side projections the posts 1016 are interposed between joint fingers 1024 thereby maintaining the posts 1016 between the linkage faces 1020, 1022 without projection beyond the faces 1020, 1022.

As further shown in FIG. 10A, 10B, the linkage members 1004, 1006 optionally include one or more fins 1012. The fins 1012 are provided, in one example, along the linkage faces 1020, 1022. The fins 1012 are, in one example, constructed with the material of the linkage members 1004, 1006. In one example, the fins 1012 are a thin portion of the linkage members 1004, 1006 that is readily deformable, for instance, when installed into a segment channel. The fins, in one example, are configured to deform, for instance, abrade, shear, compress or the like when inserted into the segment channels to accordingly provide a snug fit between the lineal segments and the articulating corner linkage 1000.

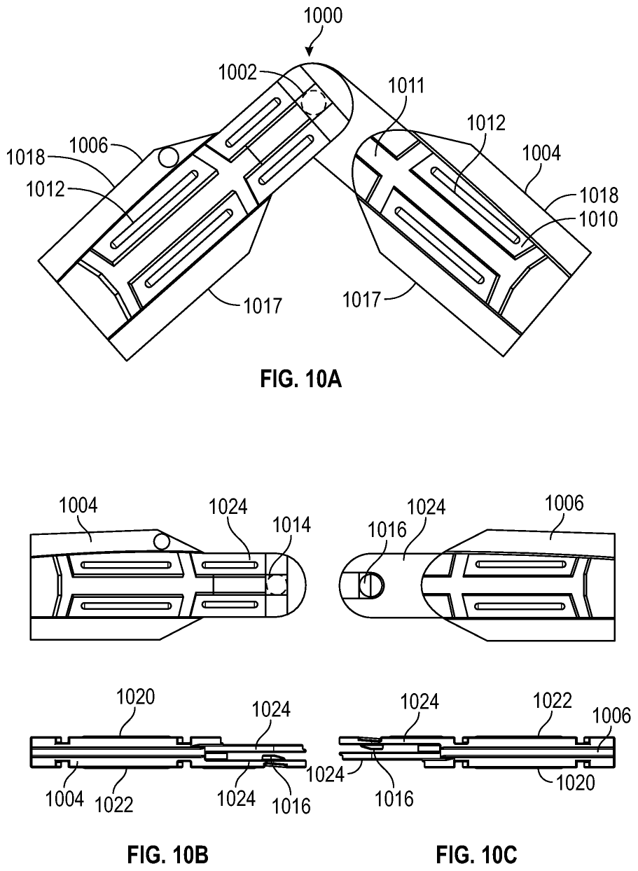

FIG. 11 is a perspective view of the articulating corner linkage 900 in a partially installed configuration relative to lineal segments 1100, 1101. In one example, the lineal segment 1100 includes a curved lineal segment such as one or more of the composite lineal segments described herein. The articulating corner linkage 900 includes linkage members 904, 906 and the linkage members 904, 906 are received in respective segment channels 1102 of the lineal segments 1100, 1101. As shown in this example, the adjustable joint 902 of the articulating corner linkage 900 is articulated (rotated, pivoted or the like) to position the adjustable joint 902 at a linkage angle corresponding to the corner angle of the lineal segments 1100, 1101. For instance, in this example, the lineal segments 1100, 1101 are provided at an orientation of approximately 135 degrees as one example of a corner angle. Correspondingly, the linkage angle of the articulating corner linkage 900 and its adjustable joint 902 is set at a corresponding linkage angle of approximately 135 degrees.

As further shown in FIG. 11, the linkage members 904, 906 are installed into one or more segment channels 1102. For instance, the linkage members 904, 906 having a combination of reliefs 911 and spines 910, are readily received within the segment channels 1102 while the spines 910 provide structural support and, in one example, engage with the walls of the segment channels 1102 to provide a snug fit.

In another example, the articulating corner linkages 900 include one or more fins 912, 918 or the like as previously described herein. These fins are, in one example, constructed with a deformable or sacrificial material. For instance, the fins include a narrow ridge of the material of the articulating corner linkage 900. As the articulating corner linkage members 904, 906 are inserted into the respective segment channels 1102 the fins 912, 918 are abraded, sheared, press fit, deformed or the like by the walls of the segment channels 1102. Accordingly, the linkage members 904, 906 are snugly received within the segment channels 1102.

Optionally, one or more setting compounds such as epoxies, hot melt or the like are delivered into the segment channels 1102, for instance, around and distributed along the articulating corner linkage 900 to permit the bonding of the linkage members 904, 906 at the linkage angle corresponding to the corner angle of the lineal segments 1100, 1101. In another example, the setting compound also sets or statically holds the articulating corner linkage 900, for instance, at its adjustable joint 902 to accordingly make the adjusted linkage angle static.

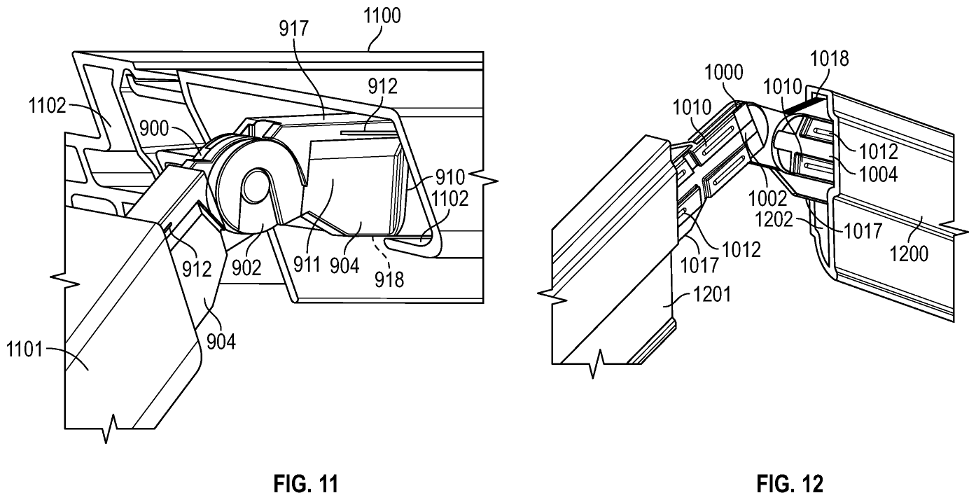

The articulating corner linkage 1000 shown in FIGS. 10A, 10B, 10C is shown in FIG. 12 in a partially installed configuration, for instance, with lineal segments 1200, 1201 illustrating one example of a corner angle and the articulating corner linkage 1000 set at a corresponding linkage angle. In this example, the corner angle corresponds to an angle of approximately 105 degrees and the articulating corner linkage including its adjustable joint 1002 is pivoted to a corresponding linkage angle of 105 degrees.

Each of the linkage segments 1004, 1006 is received in a corresponding segment channel 1202 of the lineal segments 1200, 1201. In this example, the lineal segment 1200 includes a specified curvature, for instance, one or more of the curvatures previously shown and described in FIGS. 1 and 2.

The linkage segments 1004, 1006 are, in one example, delivered into the segment channels 1202 and one or more features such as the fins 1012 are deformably engaged against one or more features enclosing the segment channels 1202 including, but not limited to, the segment walls. In one example, the fins 1012 are deformable, for instance, the fins are configured to abrade, shear, deflect, compress or the like to provide a snug coupling between the articulating corner linkage 1000 and the lineal segments 1200, 1201.

After installation of the articulating corner linkage 1000, for instance, with the linkage segments 1004, 1006 inserted into each of the segment channels 1202, in one example, a setting compound such as a hot melt, epoxy or the like is administered to the corner formed by the lineal segments 1200, 1201. For instance, in one example, a small port is formed in one or both of the lineal segments 1200, 1202 or the setting compound is administered to the articulating joint and the segment channels 1202 prior to full connection between the lineal segments 1200, 1201. The setting compound is administered, in one example, at the adjustable joint 1002 and is distributed along the articulating corner linkage 1000, for instance, according to the reliefs 1011 (e.g., grooves, channels or the like) formed to either side of the one or more spines 1010 provided along the linkage faces 1020, 1022. The setting compound is distributed along the articulating corner linkage 1000 and permits the bonding and setting of the articulating corner linkage 1000, for instance, to hold the adjustable joint 1002 statically at the specified linkage angle and at the same time holding the lineal segments 1200, 1201 at the corner angle.

### Various Notes

Aspect 1 can include subject matter such as a fenestration assembly comprising: a plurality of lineal segments, each of the lineal segments extending between first and second ends, one or more of the lineal segments of the plurality of lineal segments is a composite lineal segment and includes: a first component lineal segment; a second component lineal segment; and wherein the first and second component lineal segments are coupled at an assembly joint in an assembled configuration; and wherein the composite lineal segment having the first and second component lineal segments in the assembly configuration is in a curved configuration.

Aspect 2 can include, or can optionally be combined with the subject matter of Aspect 1, to optionally include wherein at least one of the first or second component lineal segments includes a foam brace within a segment channel of the first or second component lineal segments.

Aspect 3 can include, or can optionally be combined with the subject matter of one or any combination of Aspects 1 or 2 to optionally include wherein at least one of the first or second component lineal segments include segment walls around the segment channel; and wherein the foam brace is configured to support the segment walls during imparting of the curved configuration.

Aspect 4 can include, or can optionally be combined with the subject matter of one or any combination of Aspects 1-3 to optionally include wherein at least one of the first or second component lineal segments includes a polymer brace within a segment channel of the first or second component lineal segments.

Aspect 5 can include, or can optionally be combined with the subject matter of one or any combination of Aspects 1-4 to optionally include wherein the composite lineal segment including the first and second component lineal segments in the assembled configuration is configured for imparting of the curved configuration.

Aspect 6 can include, or can optionally be combined with the subject matter of Aspects 1-5 to optionally include wherein the first component lineal segment includes one or more of a first material or a first finish and the second component lineal segment includes one or more of a second material or a second finish, and one or more of the first or second materials or the first or second finishes are different.

Aspect 7 can include, or can optionally be combined with the subject matter of Aspects 1-6 to optionally include wherein the first component lineal segment is an interior facing component lineal segment having an aesthetic finish; and the second component lineal segment is an exterior facing component lineal segment having at least an ultraviolet resistant material.

Aspect 8 can include, or can optionally be combined with the subject matter of Aspects 1-7 to optionally include wherein the assembly joint includes: a joint socket with the first component lineal segment; and a locking feature with the second component lineal segment, the locking feature received in the joint socket.

Aspect 9 can include, or can optionally be combined with the subject matter of Aspects 1-8 to optionally include wherein the plurality of lineal segments include the composite lineal segment with the curved configuration and an additional lineal segment, the composite lineal segment and the additional lineal segment are joined at a corner with an articulating corner linkage, the articulating corner linkage includes: a first linkage member; a second linkage member; and an adjustable joint interconnecting the first and second linkage members, the first and second linkage members are rotatable relative to each other at the adjustable joint.

Aspect 10 can include, or can optionally be combined with the subject matter of Aspects 1-9 to optionally include wherein the corner includes a corner angle, and the first and second linkage members of the articulating corner linkage have a linkage angle at the adjustable joint matching the corner angle.

Aspect 11 can include, or can optionally be combined with the subject matter of Aspects 1-10 to optionally include one or more of a fenestration frame or a sash, and one or both of the fenestration frame or the sash includes the plurality of lineal segments coupled at the respective first and second ends.

Aspect 12 can include, or can optionally be combined with the subject matter of Aspects 1-11 to optionally include a fenestration assembly comprising: at least one fenestration frame, the fenestration frame includes: a first lineal segment extending between first segment ends and having a first segment channel; a second lineal segment extending between second segment ends and having a second segment channel; and wherein the first and second segment ends are coupled at a corner having a corner angle, the first and second lineal segments oriented at the corner angle; and an articulating corner linkage coupling the first and second segments at the corner, the articulating corner linkage includes: a first linkage member received in the first segment channel; a second linkage member received in the second segment channel; an adjustable joint interconnecting the first and second linkage members, the first and second linkage members are rotatable relative to each other at the adjustable joint; and wherein the first and second linkage members include a linkage angle at the adjustable joint corresponding to the corner angle.

Aspect 13 can include, or can optionally be combined with the subject matter of Aspects 1-12 to optionally include wherein the at least one fenestration frame includes a peripheral frame or a sash frame, the sash frame coupled with the peripheral frame.

Aspect 14 can include, or can optionally be combined with the subject matter of Aspects 1-13 to optionally include wherein the at least one fenestration frame includes both a peripheral frame and a sash frame, the sash frame coupled with the peripheral frame.

Aspect 15 can include, or can optionally be combined with the subject matter of Aspects 1-14 to optionally include wherein one or more of the first or second lineal segments include first and second segment walls extending around the respective first and second segment channels; and wherein one or more of the first or second linkage members include fitting fins deformably engaged with the respective first or second segment walls.

Aspect 16 can include, or can optionally be combined with the subject matter of Aspects 1-15 to optionally include wherein the fitting fins include sacrificial fitting fins configured to abrade with the first linkage member received in the first segment channel or with the second linkage member received in the second segment channel.

Aspect 17 can include, or can optionally be combined with the subject matter of Aspects 1-16 to optionally include wherein one or more of the first or second linkage members include adhesive channels configured to distribute adhesives from proximate the adjustable joint into the segment channels.

Aspect 18 can include, or can optionally be combined with the subject matter of Aspects 1-17 to optionally include wherein the first and second linkage members each include two or more joint fingers, and the adjustable joint includes the joint fingers of the first and second linkage members interleaved.

Aspect 19 can include, or can optionally be combined with the subject matter of Aspects 1-18 to optionally include wherein one of the first or second linkage members includes a pivot post, the other of the second or first linkage members includes a post socket, and the pivot post is received in the post socket at the adjustable joint.

Aspect 20 can include, or can optionally be combined with the subject matter of Aspects 1-19 to optionally include wherein each of the first and second linkage members includes superior and inferior linkage faces, and the pivot post is between the superior and inferior linkage faces.

Aspect 21 can include, or can optionally be combined with the subject matter of Aspects 1-20 to optionally include wherein the pivot post is entirely between the linkage faces.

Aspect 22 can include, or can optionally be combined with the subject matter of Aspects 1-21 to optionally include wherein one or more of the first or second linkage members includes superior and inferior linkage faces, and at least one of the superior or inferior linkage faces includes: a spine flush with the associated superior or inferior linkage face; and a relief recessed from the associated superior or inferior linkage face.

Aspect 23 can include, or can optionally be combined with the subject matter of Aspects 1-22 to optionally include wherein one or more of the first or second lineal segments is a composite lineal segment and includes: a first component lineal segment; a second component lineal segment; and wherein the first and second component lineal segments are coupled along an assembly joint in an assembled configuration, and the composite lineal segment in the assembled configuration is configured for imparting of a specified curvature.

Aspect 24 can include, or can optionally be combined with the subject matter of Aspects 1-23 to optionally include a method for imparting a specified curvature to a composite lineal segment comprising: heating the composite lineal segment to a plastic deformation temperature, the composite lineal segment including at least a first component lineal segment and a second component lineal segment coupled along an assembly joint; and imparting the specified curvature to the composite lineal segment with a navigated curving assembly, imparting the specified curvature includes: navigating the composite lineal segment into one or more guide profiles; and deforming the composite lineal segment to the specified curvature according to the one or more guide profiles arranged with the specified curvature.

Aspect 25 can include, or can optionally be combined with the subject matter of Aspects 1-24 to optionally include wherein navigating the composite lineal segment into one or more guide profiles includes navigating the composite lineal segment into the one or more guide profiles having inner and outer component guide profiles.

Aspect 26 can include, or can optionally be combined with the subject matter of Aspects 1-25 to optionally include ejecting the composite lineal segment from the one or more guide profiles after imparting the curve.

Aspect 27 can include, or can optionally be combined with the subject matter of Aspects 1-26 to optionally include bracing the composite lineal segment with at least one foam brace within a segment channel of the composite lineal segment while imparting the curve.

Aspect 28 can include, or can optionally be combined with the subject matter of Aspects 1-27 to optionally include bracing the composite lineal segment with at least one polymer brace within a segment channel of the composite lineal segment while imparting the curve.

Aspect 29 can include, or can optionally be combined with the subject matter of Aspects 1-28 to optionally include wherein navigating the composite lineal segment into the one or more guide profiles includes rotating a boom coupled with the composite lineal segment along the one or more guide profiles.

Aspect 30 can include, or can optionally be combined with the subject matter of Aspects 1-29 to optionally include wherein navigating the composite lineal segment into the one or more guide profiles includes pulling the composite lineal segment into the one or more guide profiles.

Aspect 31 can include, or can optionally be combined with the subject matter of Aspects 1-30 to optionally include wherein imparting the specified curvature to the composite lineal segment includes imparting the specified curvature a fenestration frame including the composite lineal segment.

Aspect 32 can include, or can optionally be combined with the subject matter of Aspects 1-31 to optionally include imparting a complementary specified curvature to a sash lineal segment including: heating the sash lineal segment to a plastic deformation temperature; and imparting the second specified curvature to the sash lineal segment with the navigated curving assembly, imparting the second specified curvature includes: navigating the sash lineal segment into one or more sash guide profiles complementary to the one or more guide profiles; and deforming the sash lineal segment to the complementary specified curvature according to the one or more sash guide profiles arranged with the complementary specified curvature that is complementary to the specified curvature.

Aspect 33 can include, or can optionally be combined with the subject matter of Aspects 1-32 to optionally include assembling the composite lineal segment including: selecting the first component lineal segment having one or more first segment characteristics from a plurality of first component lineal segments having different first segment characteristics; selecting the second component lineal segment having one or more second segment characteristics from a plurality of second component lineal segments having different second segment characteristics; and assembling the first and second component lineal segments with the assembly joint.

Aspect 34 can include, or can optionally be combined with the subject matter of Aspects 1-33 to optionally include joining the composite lineal segment with a lineal segment with an articulating corner linkage including: setting a linkage angle of an adjustable joint of the articulating corner linkage to correspond with a corner angle between composite lineal segment and the lineal segment; inserting a first linkage member of the articulating corner linkage in a first segment channel of the composite lineal segment; inserting a second linkage member of the articulating corner linkage a second segment channel of the lineal segment.

Aspect 35 can include, or can optionally be combined with the subject matter of Aspects 1-34 to optionally include wherein joining the composite lineal segment with the lineal segment includes distributing a setting compound into one or more of the first or second segment channels.

Aspect 36 can include, or can optionally be combined with the subject matter of Aspects 1-35 to optionally include wherein distributing the setting compound includes distributing the setting compound with one or more channels of the first or second linkage members.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A fenestration assembly comprising:
a plurality of lineal segments, each of the lineal segments extending between first and second ends, one or more of the lineal segments of the plurality of lineal segments is a composite lineal segment and includes:
a first component lineal segment;
a second component lineal segment; and
wherein the first and second component lineal segments are coupled at an assembly joint in an assembled configuration; and
wherein the composite lineal segment having the first and second component lineal segments in the assembly configuration is in a curved configuration.

2. The fenestration assembly of claim 1, wherein at least one of the first or second component lineal segments includes a foam brace within a segment channel of the first or second component lineal segments.

3. The fenestration assembly of claim 2, wherein at least one of the first or second component lineal segments include segment walls around the segment channel; and
wherein the foam brace is configured to support the segment walls during imparting of the curved configuration.

4. The fenestration assembly of claim 1, wherein at least one of the first or second component lineal segments includes a polymer brace within a segment channel of the first or second component lineal segments.

5. The fenestration assembly of claim 1, wherein the composite lineal segment including the first and second component lineal segments in the assembled configuration is configured for imparting of the curved configuration.

6. The fenestration assembly of claim 1, wherein the first component lineal segment includes one or more of a first material or a first finish and the second component lineal segment includes one or more of a second material or a second finish, and one or more of the first or second materials or the first or second finishes are different.

7. The fenestration assembly of claim 6, wherein the first component lineal segment is an interior facing component lineal segment having an aesthetic finish; and
the second component lineal segment is an exterior facing component lineal segment having at least an ultraviolet resistant material.

8. The fenestration assembly of claim 1, wherein the assembly joint includes:
a joint socket with the first component lineal segment; and
a locking feature with the second component lineal segment, the locking feature received in the joint socket.

9. The fenestration assembly of claim 1, wherein the plurality of lineal segments include the composite lineal segment with the curved configuration and an additional lineal segment, the composite lineal segment and the additional lineal segment are joined at a corner with an articulating corner linkage, the articulating corner linkage includes:
a first linkage member;
a second linkage member; and
an adjustable joint interconnecting the first and second linkage members, the first and second linkage members are rotatable relative to each other at the adjustable joint.

10. The fenestration assembly of claim 9, wherein the corner includes a corner angle, and the first and second linkage members of the articulating corner linkage have a linkage angle at the adjustable joint matching the corner angle.

11. The fenestration assembly of claim 1 comprising one or more of a fenestration frame or a sash, and one or both of the fenestration frame or the sash includes the plurality of lineal segments coupled at the respective first and second ends.

12. A fenestration assembly comprising:
at least one fenestration frame, the fenestration frame includes:
a first lineal segment extending between first segment ends and having a first segment channel;
a second lineal segment extending between second segment ends and having a second segment channel; and
wherein the first and second segment ends are coupled at a corner having a corner angle, the first and second lineal segments oriented at the corner angle; and
an articulating corner linkage coupling the first and second segments at the corner, the articulating corner linkage includes:
a first linkage member received in the first segment channel;
a second linkage member received in the second segment channel;
an adjustable joint interconnecting the first and second linkage members, the first and second linkage members are rotatable relative to each other at the adjustable joint; and
wherein the first and second linkage members include a linkage angle at the adjustable joint corresponding to the corner angle.

13. The fenestration assembly of claim 12, wherein the at least one fenestration frame includes a peripheral frame or a sash frame, the sash frame coupled with the peripheral frame.

14. The fenestration assembly of claim 13, wherein the at least one fenestration frame includes both a peripheral frame and a sash frame, the sash frame coupled with the peripheral frame.

15. The fenestration assembly of claim 12, wherein one or more of the first or second lineal segments include first and second segment walls extending around the respective first and second segment channels; and
wherein one or more of the first or second linkage members include fitting fins deformably engaged with the respective first or second segment walls.

16. The fenestration assembly of claim 15, wherein the fitting fins include sacrificial fitting fins configured to abrade with the first linkage member received in the first segment channel or with the second linkage member received in the second segment channel.

17. The fenestration assembly of claim 12, wherein one or more of the first or second linkage members include adhesive channels configured to distribute adhesives from proximate the adjustable joint into the segment channels.

18. The fenestration assembly of claim 12, wherein the first and second linkage members each include two or more joint fingers, and the adjustable joint includes the joint fingers of the first and second linkage members interleaved.

19. The fenestration assembly of claim 12, wherein one of the first or second linkage members includes a pivot post, the other of the second or first linkage members includes a post socket, and the pivot post is received in the post socket at the adjustable joint.

20. The fenestration assembly of claim 19, wherein each of the first and second linkage members includes superior and inferior linkage faces, and the pivot post is between the superior and inferior linkage faces.

21. The fenestration assembly of claim 20, wherein the pivot post is entirely between the linkage faces.

22. The fenestration assembly of claim 12, wherein one or more of the first or second linkage members includes superior and inferior linkage faces, and at least one of the superior or inferior linkage faces includes:
a spine flush with the associated superior or inferior linkage face; and
a relief recessed from the associated superior or inferior linkage face.

23. The fenestration assembly of claim 12, wherein one or more of the first or second lineal segments is a composite lineal segment and includes:
a first component lineal segment;
a second component lineal segment; and
wherein the first and second component lineal segments are coupled along an assembly joint in an assembled configuration, and the composite lineal segment in the assembled configuration is configured for imparting of a specified curvature.

24. A method for imparting a specified curvature to a composite lineal segment comprising:
heating the composite lineal segment to a plastic deformation temperature, the composite lineal segment including at least a first component lineal segment and a second component lineal segment coupled along an assembly joint; and
imparting the specified curvature to the composite lineal segment with a navigated curving assembly, imparting the specified curvature includes:
navigating the composite lineal segment into one or more guide profiles; and
deforming the composite lineal segment to the specified curvature according to the one or more guide profiles arranged with the specified curvature.

25. The method of claim 24, wherein navigating the composite lineal segment into one or more guide profiles includes navigating the composite lineal segment into the one or more guide profiles having inner and outer component guide profiles.

26. The method of claim 24 comprising ejecting the composite lineal segment from the one or more guide profiles after imparting the curve.

27. The method of claim 24 comprising bracing the composite lineal segment with at least one foam brace within a segment channel of the composite lineal segment while imparting the curve.

28. The method of claim 24 comprising bracing the composite lineal segment with at least one polymer brace within a segment channel of the composite lineal segment while imparting the curve.

29. The method of claim 24, wherein navigating the composite lineal segment into the one or more guide profiles includes rotating a boom coupled with the composite lineal segment along the one or more guide profiles.

30. The method of claim 24, wherein navigating the composite lineal segment into the one or more guide profiles includes pulling the composite lineal segment into the one or more guide profiles.

31. The method of claim 24, wherein imparting the specified curvature to the composite lineal segment includes imparting the specified curvature a fenestration frame including the composite lineal segment.

32. The method of claim 31 comprising imparting a complementary specified curvature to a sash lineal segment including:
heating the sash lineal segment to a plastic deformation temperature; and
imparting the second specified curvature to the sash lineal segment with the navigated curving assembly, imparting the second specified curvature includes:
navigating the sash lineal segment into one or more sash guide profiles complementary to the one or more guide profiles; and
deforming the sash lineal segment to the complementary specified curvature according to the one or more sash guide profiles arranged with the complementary specified curvature that is complementary to the specified curvature.

33. The method of claim 24 comprising assembling the composite lineal segment including:
selecting the first component lineal segment having one or more first segment characteristics from a plurality of first component lineal segments having different first segment characteristics;
selecting the second component lineal segment having one or more second segment characteristics from a plurality of second component lineal segments having different second segment characteristics; and
assembling the first and second component lineal segments with the assembly joint.

34. The method of claim 24 comprising joining the composite lineal segment with a lineal segment with an articulating corner linkage including:
setting a linkage angle of an adjustable joint of the articulating corner linkage to correspond with a corner angle between composite lineal segment and the lineal segment;
inserting a first linkage member of the articulating corner linkage in a first segment channel of the composite lineal segment;
inserting a second linkage member of the articulating corner linkage a second segment channel of the lineal segment.

35. The method of claim 34, wherein joining the composite lineal segment with the lineal segment includes distributing a setting compound into one or more of the first or second segment channels.

36. The method of claim 35, wherein distributing the setting compound includes distributing the setting compound with one or more channels of the first or second linkage members.
